(19) United States
(12) Patent Application Publication
(10) Pub. No.: US 2017/0121182 A1
(43) Pub. Date: May 4, 2017

(54) CALCINATION PROCESSES FOR PREPARING VARIOUS TYPES OF ALUMINA

(71) Applicant: ORBITE TECHNOLOGIES INC., St-Laurent (CA)

(72) Inventors: Ebrahim ALIZADEH, Laval (CA); Hubert DUMONT, Laval (CA); Jonathan BOUFFARD, Montréal (CA)

(73) Assignee: ORBITE TECHNOLOGIES INC., St-Laurent, Quebec (CA)

(21) Appl. No.: 15/314,683

(22) PCT Filed: May 29, 2015
(86) PCT No.: PCT/CA2015/000354

§ 371 Date: Nov. 29, 2016

Related U.S. Application Data
(60) Provisional application No. 62/005,160, filed on May 30, 2014.

(51) Int. Cl. C01F 7/44; C01F 7/30

(52) U.S. Cl. CPC C01F 7/442; C01F 7/306; C01P 2002/88

(57) ABSTRACT

There are provided processes for converting alumina into α-Al₂O₃ or transition alumina that comprise heating the alumina at a temperature of about 900° C. to about 1200° C. in the presence of steam and optionally at least one gas under conditions suitable to obtain the α-Al₂O₃ or transition alumina. For example, the alumina can comprise a transition alumina (such as γ-Al₂O₃), an amorphous alumina or a mixture thereof.

The present application claims priority on U.S. 62/005,160 filed on May 30, 2014, which is hereby incorporated by reference in its entirety.

The present disclosure relates to improvements in the field of chemistry applied to the production of alumina. For example, it relates to calcination processes for the production of α-alumina or transition alumina via the calcination of alumina.

Corundum or alpha alumina is the most stable structure of alumina and is one of the hardest minerals after diamond. It is the raw material for the production, for example, of many ceramic materials and refractories. Alpha alumina may be produced by the thermal calcination of transition alumina. Most commercially available transition alumina is produced through the Bayer process, where bauxite is mixed with hot concentrated NaOH, digesting most of the alumina, silica and other impurities. The Bayer process produces gibbsite (Al(OH)₃) that can then be thermally decomposed into different transition alumina states, for example, those which are useful for smelter applications (i.e. smelter grade alumina, SGA). Due to the presence of NaOH in the Bayer process, the final product contains a significant amount of Na₂O content (0.3-0.4% wt). Other oxides are also present but in smaller quantities such as calcium, silicon and gallium. The level of impurities in SGA is not useful for the modern applications of alumina, for example in making synthetic sapphire for use, for example in fibre optics, in LED lighting and Li-ion batteries separators, for example for home and automotive markets.

Known processes for the preparation of alpha alumina from transition alumina are carried out at high temperature. For example, this temperature has been reported to be 1150-1200° C. in an air environment (Park, K. Y.; Jeong, J. Manufacture of low-soda alumina from clay. Industrial and Engineering Chemistry 1996 (35) 4379-4385; Petzold, D.; Naumann, R. J. Thermoanalytical studies on the decomposition of aluminum chloride hexahydrate. Journal of thermal analysis 1981 (20) 71-86). Conducting the reaction at such a high temperature, for example when it is carried out at an industrial scale, uses intensive energy to maintain the material at this temperature. The material selection for equipment manufacturing may be another challenge at such a high temperature.

It would thus be desirable to be provided with a process for producing α-alumina or transition alumina that would at least partially solve one of the problems mentioned or that would be an alternative to the known processes for producing α-alumina or transition alumina.

Therefore according to an aspect of the present disclosure, there is provided a process for converting a first type of alumina into a second type of alumina, the process comprising heating the alumina at a temperature of about 900° C. to about 1200° C. in the presence of steam and optionally at least one gas under conditions suitable to obtain the second type of alumina.

According to another aspect of the present disclosure, there is provided a process for converting a first type of alumina into a second type of alumina, the process comprising heating the alumina at a temperature of about 900° C. to about 1200° C. in the presence of steam and optionally at least one gas chosen from air, argon, nitrogen, carbon dioxide, hydrogen and hydrochloric acid under conditions suitable to obtain the second type of alumina.

According to an aspect of the present disclosure, there is provided a process for converting a first type of alumina into a second type of alumina, the process comprising heating the alumina at a temperature of about 950° C. to about 1200° C. in the presence of steam and optionally at least one gas chosen from air, argon, nitrogen, carbon dioxide, hydrogen and hydrochloric acid under conditions suitable to obtain the second type of alumina.

According to an aspect of the present disclosure, there is provided a process for converting a first type of alumina into a second type of alumina, the process comprising heating the alumina at a temperature of about 900° C. to about 1150° C. in the presence of steam and optionally at least one gas chosen from air, argon, nitrogen, carbon dioxide hydrogen and hydrochloric acid under conditions suitable to obtain the second type of alumina.

According to an aspect of the present disclosure, there is provided a process for converting a first type of alumina into a second type of alumina, the process comprising heating the alumina at a temperature of about 950° C. to about 1150° C. in the presence of steam and optionally at least one gas chosen from air, argon, nitrogen, carbon dioxide, hydrogen and hydrochloric acid under conditions suitable to obtain the second type of alumina.

According to an aspect of the present disclosure, there is provided a process for treating alumina, the process comprising heating the alumina at a temperature of about 900° C. to about 1200° C. in the presence of steam and optionally at least one gas.

According to an aspect of the present disclosure, there is provided a process for treating alumina, the process comprising heating the alumina at a temperature of about 900° C. to about 1200° C. in the presence of steam and optionally at least one gas chosen from air, argon, nitrogen, carbon dioxide hydrogen and hydrochloric acid.

According to an aspect of the present disclosure, there is provided a process for treating alumina, the process comprising heating the alumina at a temperature of about 950° C. to about 1200° C. in the presence of steam and optionally at least one gas chosen from air, argon, nitrogen, carbon dioxide, hydrogen and hydrochloric acid.

According to an aspect of the present disclosure, there is provided a process for treating alumina, the process comprising heating the alumina at a temperature of about 900° C. to about 1150° C. in the presence of steam and optionally at least one gas chosen from air, argon, nitrogen, carbon dioxide, hydrogen and hydrochloric acid.

According to an aspect of the present disclosure, there is provided a process for treating alumina, the process comprising heating the alumina at a temperature of about 950° C. to about 1150° C. in the presence of steam and optionally at least one gas chosen from air, argon, nitrogen, carbon dioxide, hydrogen and hydrochloric acid.

According to another aspect of the present disclosure, there is provided a process for converting alumina into α-Al₂O₃, the process comprising heating the alumina at a temperature of about 900° C. to about 1200° C. in the presence of steam and optionally at least one gas, under conditions suitable to obtain the α-Al₂O₃.

According to another aspect of the present disclosure, there is provided a process for converting alumina into α-Al₂O₃, the process comprising heating the alumina at a temperature of about 900° C. to about 1200° C. in the presence of steam and optionally at least one gas chosen from air, argon, nitrogen, carbon dioxide, hydrogen and hydrochloric acid under conditions suitable to obtain the α-Al₂O₃.

According to another aspect of the present disclosure, there is provided a process for converting alumina into α-Al₂O₃, the process comprising heating the alumina at a temperature of about 950° C. to about 1200° C. in the presence of steam and optionally at least one gas chosen from air, argon, nitrogen, carbon dioxide, hydrogen and hydrochloric acid, under conditions suitable to obtain the α-Al₂O₃.

According to another aspect of the present disclosure, there is provided a process for converting alumina into α-Al₂O₃, the process comprising heating the alumina at a temperature of about 900° C. to about 1150° C. in the presence of steam and optionally at least one gas chosen from air, argon, nitrogen, carbon dioxide, hydrogen and hydrochloric acid, under conditions suitable to obtain the α-Al₂O₃.

According to another aspect of the present disclosure, there is provided a process for converting alumina into α-Al₂O₃, the process comprising heating the alumina at a temperature of about 950° C. to about 1150° C. in the presence of steam and optionally at least one gas chosen from air, argon, nitrogen, carbon dioxide, hydrogen and hydrochloric acid, under conditions suitable to obtain the α-Al₂O₃.

According to another aspect of the present disclosure, there is provided a process for converting AlCl₃.6H₂O into alumina, the process comprising heating AlCl₃.6H₂O at a temperature of about 900° C. to about 1200° C. in the presence of steam and optionally at least one gas, under conditions suitable to obtain the alumina.

According to another aspect of the present disclosure, there is provided a process for converting AlCl₃.6H₂O into α-Al₂O₃, the process comprising heating AlCl₃.6H₂O at a temperature of about 900° C. to about 1200° C. in the presence of steam and optionally at least one gas, under conditions suitable to obtain the α-Al₂O₃.

According to another aspect of the present disclosure, there is provided a process for converting alumina into α-Al₂O₃ or transition alumina, the process comprising heating the alumina at a temperature of about 900° C. to about 1200° C. in the presence of steam and optionally at least one gas, under conditions suitable to obtain the α-Al₂O₃ or transition alumina.

According to another aspect of the present disclosure, there is provided a process for converting alumina into α-Al₂O₃ or transition alumina, the process comprising heating the alumina at a temperature of about 900° C. to about 1200° C. in the presence of steam and optionally at least one gas chosen from air, argon, nitrogen, carbon dioxide hydrogen and hydrochloric acid under conditions suitable to obtain the α-Al₂O₃ or transition alumina.

According to another aspect of the present disclosure, there is provided a process for converting alumina into α-Al₂O₃ or transition alumina, the process comprising heating the alumina at a temperature of about 950° C. to about 1200° C. in the presence of steam and optionally at least one gas chosen from air, argon, nitrogen, carbon dioxide, hydrogen and hydrochloric acid, under conditions suitable to obtain the α-Al₂O₃ or transition alumina.

According to another aspect of the present disclosure, there is provided a process for converting alumina into α-Al₂O₃ or transition alumina, the process comprising heating the alumina at a temperature of about 900° C. to about 1150° C. in the presence of steam and optionally at least one gas chosen from air, argon, nitrogen, carbon dioxide, hydrogen and hydrochloric acid, under conditions suitable to obtain the α-Al₂O₃ or transition alumina.

According to another aspect of the present disclosure, there is provided a process for converting alumina into α-Al₂O₃ or transition alumina, the process comprising heating the alumina at a temperature of about 950° C. to about 1150° C. in the presence of steam and optionally at least one gas chosen from air, argon, nitrogen, carbon dioxide, hydrogen and hydrochloric acid, under conditions suitable to obtain the α-Al₂O₃ or transition alumina.

According to another aspect of the present disclosure, there is provided a process for converting AlCl₃.6H₂O into α-Al₂O₃ or transition alumina, the process comprising heating AlCl₃.6H₂O at a temperature of about 900° C. to about 1200° C. in the presence of steam and optionally at least one gas, under conditions suitable to obtain the α-Al₂O₃ or transition alumina.

The use of a steam environment in the calcination reaction decreases the alpha alumina formation temperature in comparison to a process which does not use steam. As a result, a smaller amount of energy may be used to maintain the calciner operation. The residence time of the alumina inside the reactor therefore may be decreased in comparison to a process which does not use steam, which may allow, for example a reduction of the reactor size. The foregoing may, for example reduce the capital and/or operational cost of the process that uses steam in comparison to a process which does not use steam.

According to another aspect of the present disclosure, there is provided a process for decomposing AlCl₃.6H₂O into γ-Al₂O₃, the process comprising heating the AlCl₃.6H₂O at a temperature of about 600° C. to about 900° C. in the presence of steam and optionally at least one gas, under conditions suitable to obtain the γ-Al₂O₃.

According to another aspect of the present disclosure, there is provided a process for decomposing AlCl₃.6H₂O into γ-Al₂O₃, the process comprising heating the AlCl₃.6H₂O at a temperature of about 600° C. to about 850° C. in the presence of steam and optionally at least one gas, under conditions suitable to obtain the γ-Al₂O₃.

According to another aspect of the present disclosure, there is provided a process for decomposing AlCl₃.6H₂O into γ-Al₂O₃, the process comprising heating the AlCl₃.6H₂O at a temperature of about 600° C. to about 800° C. in the presence of steam and optionally at least one gas, under conditions suitable to obtain the γ-Al₂O₃.

According to another aspect of the present disclosure, there is provided a process for decomposing AlCl₃.6H₂O into γ-Al₂O₃, the process comprising heating the AlCl₃.6H₂O at a temperature of about 600° C. to about 800° C. in the presence of steam and optionally at least one gas chosen from air, argon, nitrogen, carbon dioxide, hydrogen and hydrochloric acid, under conditions suitable to obtain the γ-Al₂O₃.

In the following drawings, which represent by way of example only, various embodiments of the disclosure:

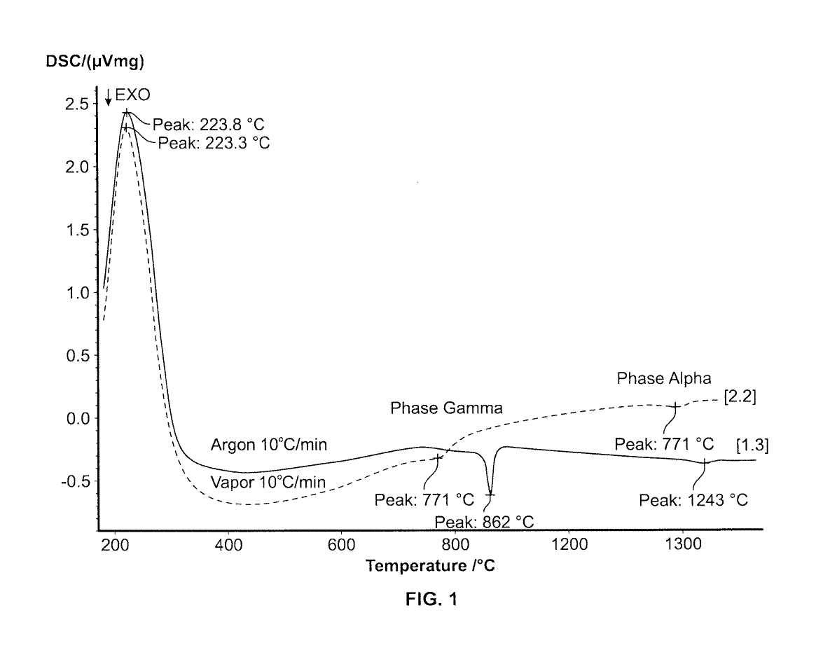

FIG. 1 is a plot showing the results of differential scanning calorimetry as a function of temperature for ACH crystals heated under an argon atmosphere at a heating rate of 10° C./min according to another comparative example for the processes of the present disclosure in comparison to ACH crystals heated under a steam atmosphere at a heating rate of 10° C./min according to an example of the processes of the present disclosure, showing a;

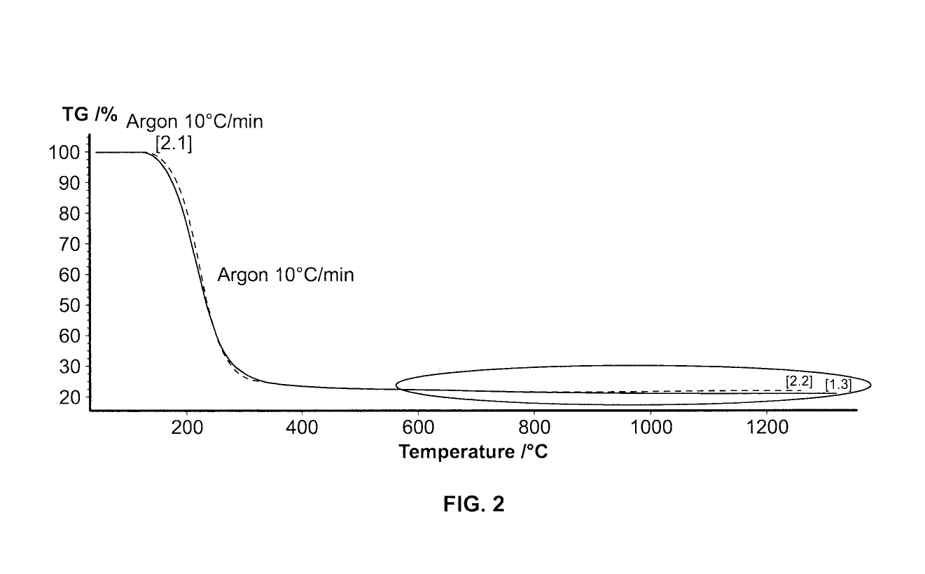

FIG. 2 is a plot showing the results of thermogravimetric analysis as a function of temperature for ACH crystals heated under an argon atmosphere at a heating rate of 10° C./min according to another comparative example for the processes of the present disclosure in comparison to ACH crystals heated under a steam atmosphere at a heating rate of 10° C./min according to an example of the processes of the present disclosure;

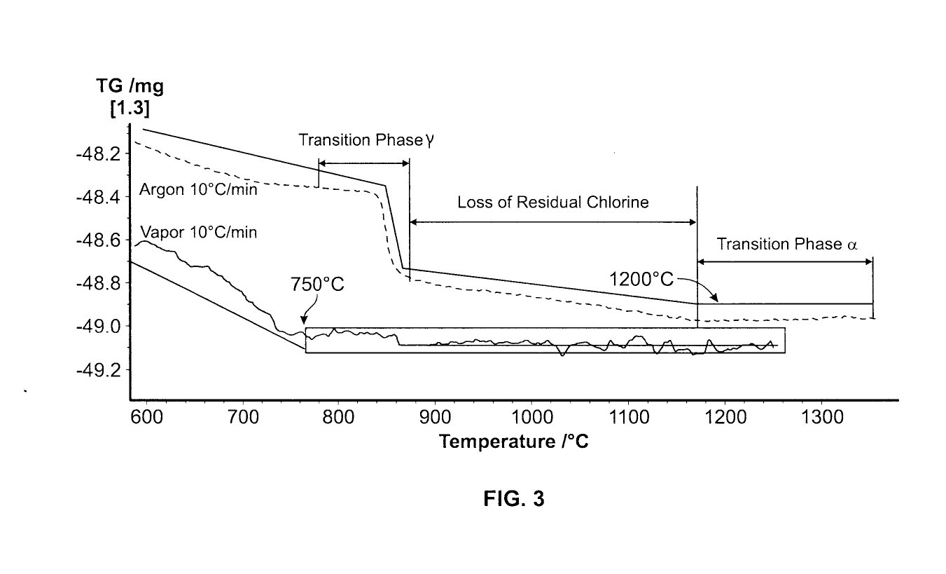

FIG. 3 is a plot showing an enlarged version of the area indicated with a circle in the results of thermogravimetric analysis shown in FIG. 2;

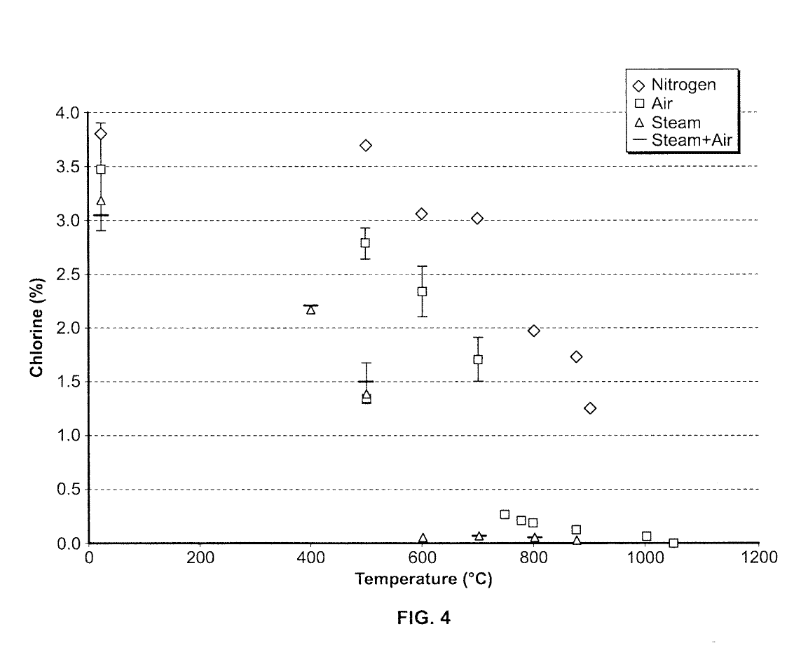

FIG. 4 is a plot showing the chlorine content (wt %) as a function of temperature (° C.) for samples of amorphous alumina heated at various temperatures while sweeping with air or nitrogen gas according to another comparative example for the processes of the present disclosure compared to samples of amorphous alumina heated at various temperatures while sweeping with steam or steam and air according to another example of the processes of the present disclosure;

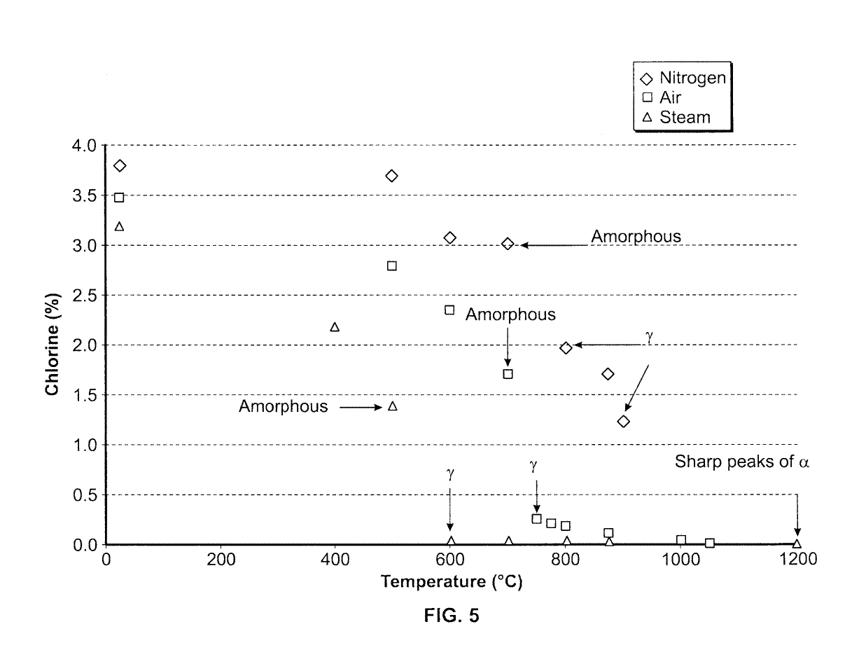

FIG. 5 is a plot showing the chlorine content (wt %) and polymorphic phase as a function of temperature (° C.) for samples of amorphous alumina heated at various temperatures while sweeping with air or nitrogen gas according to another comparative example for the processes of the present disclosure compared to samples of amorphous alumina heated at various temperatures while sweeping with steam according to another example of the processes of the present disclosure;

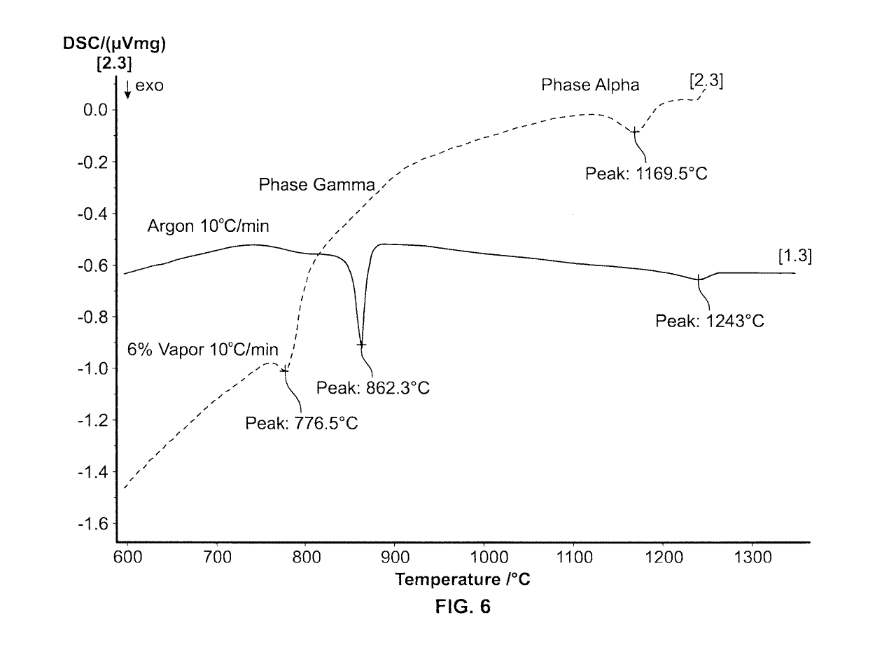

FIG. 6 is a plot showing the results of differential scanning calorimetry as a function of temperature for ACH crystals heated under an argon atmosphere at a heating rate of 10° C./min according to another comparative example for the processes of the present disclosure in comparison to ACH crystals heated under an environment comprising 6% of steam in argon at a heating rate of 10° C./min according to an example of the processes of the present disclosure; and

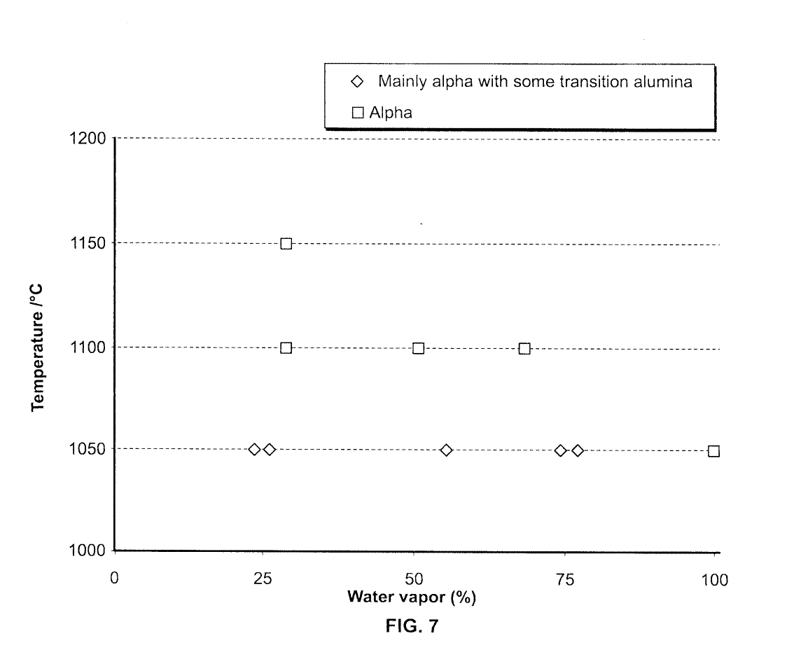

FIG. 7 is a plot showing the influence of the concentration of water vapor on the temperature necessary to reach the conversion towards α-alumina according to another example of the present disclosure.

The term “suitable” as used herein means that the selection of the particular conditions would depend on the specific manipulation or operation to be performed, but the selection would be well within the skill of a person trained in the art. All processes described herein are to be conducted under conditions sufficient to provide the desired product quality. A person skilled in the art would understand that all reaction conditions, including, when applicable, for example, reaction time, reaction temperature, reaction pressure, reactant ratio, flow rate, reactant purity, and the type of reactor used can be varied to optimize the yield of the desired product as well as its properties and it is within their skill to do so.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “about” and “approximately” as used herein mean a reasonable amount of deviation of the modified term such that the end result is not significantly changed. These terms of degree should be construed as including a deviation of ±10% of the modified term if this deviation would not negate the meaning of the word it modifies.

The terms “smelter grade alumina” or “SGA” as used herein refer to a grade of alumina that may be useful for processes for preparing aluminum metal. Smelter grade alumina typically comprises α-Al₂O₃ in an amount of less than about 5 wt %, based on the total weight of the smelter grade alumina.

The terms “high purity alumina” or “HPA” as used herein refer to a grade of alumina that comprises alumina in an amount of 99 wt % or greater, based on the total weight of the high purity alumina.

The expression “transition alumina” as used herein refers to a polymorphic form of alumina other than α-alumina. For example, the transition alumina can be χ-Al₂O₃, κ-Al₂O₃, γ-Al₂O₃, θ-Al₂O₃, δ-Al₂O₃, η-Al₂O₃, ρ-Al₂O₃ or combinations thereof.

The expression “amorphous alumina” as used herein refers to a non-crystalline polymorph of alumina that lacks the long-range order characteristic of a crystal.

The below presented examples are non-limitative and are used to better exemplify the processes of the present disclosure.

For example, the at least one gas can be chosen from air, argon, nitrogen, carbon dioxide, hydrogen and hydrochloric acid.

For example, the first type of alumina can be chosen from amorphous alumina, transition alumina and a mixture thereof.

For example, the second type of alumina can be chosen from amorphous alumina, transition alumina, α-alumina and mixtures thereof.

For example, the first type of alumina can be chosen from χ-Al₂O₃, κ-Al₂O₃, γ-Al₂O₃, θ-Al₂O₃, δ-Al₂O₃, η-Al₂O₃, ρ-Al₂O₃ and mixtures thereof.

For example, the second type of alumina can be chosen from α-Al₂O₃, χ-Al₂O₃, κ-Al₂O₃, γ-Al₂O₃, θ-Al₂O₃, δ-Al₂O₃, η-Al₂O₃, ρ-Al₂O₃ and mixtures thereof.

For example, treating the alumina can be useful for modifying the physical and/or chemical properties of the alumina.

For example, treating the alumina can be useful for modifying the physicochemical properties of the alumina.

The calcination processes of the present disclosure, wherein alumina is heated in the presence of steam, and optionally at least one gas chosen from air, argon, nitrogen, carbon dioxide, hydrogen and hydrochloric acid, can be carried out, for example, in a single step reactor at a temperature as low as about 900 or 950° C., wherein substantially all or all of the alumina such as transition alumina can be converted into alpha alumina or transition alumina. The processes of the present disclosure can be carried out at a temperature that is lower than the temperatures used when the calcination is carried out in the presence of air (typically about 1150-1200° C.). For example, with similar reaction conditions at a temperature of about 1050° C., when air is used to fill the reaction chamber, only about 25% of transition alumina is converted into alpha alumina. In the processes of the present disclosure the residence time of material inside the reactor can be, for example one to four hours.

For example, the alumina can be heated at a temperature of about 950° C. to about 1200° C., about 950° C. to about 1150° C., about 950° C. to about 1100° C., about 1000° C. to about 1100° C. or about 1000° C. to about 1150° C. For example, the alumina can be heated at a temperature of about 1000° C. to about 1150° C. For example, the alumina can be heated at a temperature of about 1050° C. to about 1080° C.

For example, the alumina can be heated at the temperature for less than about 10 hours. For example, the alumina can be heated at the temperature for less than about 9 hours. For example, the alumina can be heated at the temperature for less than about 8 hours. For example, the alumina can be heated at the temperature for less than about 7 hours. For example, the alumina can be heated at the temperature for less than about 6 hours. For example, the alumina can be heated at the temperature for less than about 5 hours. For example, the alumina can be heated at the temperature for less than about 4 hours. For example, the alumina can be heated at the temperature for less than about 3 hours. For example, the alumina can be heated at the temperature for less than about 2 hours. For example, the alumina can be heated at the temperature for less than about 1 hour. For example, the alumina can be heated at the temperature for about 1 hour to about 4 hours. For example, the alumina can be heated at the temperature for about 1 hour to about 2 hours.

The calcination processes of the present disclosure, wherein ACH is heated in the presence of steam, and optionally at least one gas chosen from air, argon, nitrogen, carbon dioxide, hydrogen and hydrochloric acid, can be carried out, for example, in a single step reactor at a temperature as low as about 900 or 950° C., wherein substantially all or all of the ACH can be converted into alumina or α-Al₂O₃. The processes of the present disclosure can be carried out at a temperature that is lower than the temperatures used when the calcination is carried out in the presence of air (typically about 1150-1200° C.).

For example, the ACH can be heated at a temperature of about 950° C. to about 1200° C., about 950° C. to about 1150° C., about 950° C. to about 1100° C., about 1000° C. to about 1100° C. or about 1000° C. to about 1150° C. For example, the ACH can be heated at a temperature of about 1000° C. to about 1150° C. For example, the ACH can be heated at a temperature of about 1050° C. to about 1080° C.

For example, the steam can be provided at a rate of about 0.001 gram to about 20 grams of steam per minute per gram of alumina. For example, the steam can be provided at a rate of about 0.01 gram to about 20 grams of steam per minute per gram of alumina. For example, the steam can be provided at a rate of about 0.1 gram to about 20 grams of steam per minute per gram of alumina. For example, the steam can be provided at a rate of about 1 gram per minute to about 20 grams of steam per minute per gram of alumina. For example, the steam can be provided at a rate of about 1 gram per minute to about 10 grams of steam per minute per gram of alumina. For example, the steam can be provided at a rate of about 3 grams per minute to about 5 grams of steam per minute per gram of alumina.

For example, the steam can be provided at a rate of about 0.05 gram to about 5 grams of steam per minute per gram of alumina. For example, the steam can be provided at a rate of about 0.1 gram to about 1 gram of steam per minute per gram of alumina. For example, the steam can be provided at a rate of about 0.15 gram to about 0.5 gram of steam per minute per gram of alumina. For example, the steam can be provided at a rate of about 0.2 gram per minute to about 0.3 grams of steam per minute per gram of alumina.

For example, the heating of the alumina at the temperature can be carried out in a chamber, the at least one gas can be introduced into the chamber prior to the heating at the temperature, and the steam and optionally at least one gas can be released from the chamber after the α-Al₂O₃ or transition alumina is obtained.

For example, the heating of the alumina at the temperature can be carried out in a chamber, the at least one gas chosen from air, argon, nitrogen, carbon dioxide, hydrogen and hydrochloric acid can be introduced into the chamber prior to the heating at the temperature, and the steam and optionally at least one gas chosen from air, argon, nitrogen, carbon dioxide, hydrogen and hydrochloric acid can be released from the chamber after the α-Al₂O₃ or transition alumina is obtained.

Optionally air, for example, in an air stream may be used to dilute the steam concentration. This may, for example, inhibit or prevent condensation of the steam at an inlet and/or an outlet of the reactor. The relative concentration of air and steam may, for example, alter other conditions useful for the calcination reaction. For example, a process wherein higher amounts of air are used to dilute the steam will typically use higher temperatures and/or longer residence times.

For example, the steam can be present in an amount that is at least a catalytic amount. For example, the steam can be present in an amount of at least about 5 wt %. For example, the steam can be present in an amount of at least about 6 wt %. For example, the steam can be present in an amount of at least about 10 wt %. For example, the steam can be present in an amount of at least about 15 wt %. For example, the steam can be present in an amount of at least about 25 wt %. For example, the steam can be present in an amount of at least about 35 wt %. For example, the steam can be present in an amount of at least about 45 wt %. For example, the steam can be present in an amount of at least about 55 wt %. For example, the steam can be present in an amount of at least about 65 wt %. For example, the steam can be present in an amount of at least about 70 wt %. For example, the steam can be present in an amount of at least about 75 wt %. For example, the steam can be present in an amount of at least about 80 wt %. For example, the steam can be present in an amount of at least about 85 wt %. For example, the steam can be present in an amount of at least about 90 wt %. For example, the steam can be present in an amount of at least about 95 wt %. For example, the steam can be present in an amount of about 5 wt % to about 95%.

For example, the alumina can be heated in the presence of steam and the at least one gas. For example, the steam can be present in an amount of about 80 wt % to about 90 wt % and the at least one gas can be present in an amount of about 10 wt % to about 20 wt %, based on the total weight of the steam and the at the least one gas. For example, the steam can be present in an amount of about 82 wt % to about 88 wt % and the at least one gas can be present in an amount of about 12 wt % to about 18 wt %, based on the total weight of the steam and the at least one gas. For example, the steam can be present in an amount of about 85 wt % and the at least one gas can be present in an amount of about 15 wt %, based on the total weight of the at least one gas.

The processes of the present disclosure can be carried out in any type of reactor that can provide suitable conditions for heating the alumina at the desired temperature, for example a temperature as previously mentioned, in the presence of steam and optionally at least one gas (for example at least one gas chosen from air, argon, nitrogen, carbon dioxide, hydrogen and hydrochloric acid) to obtain the α-Al₂O₃ or transition alumina. Because the calcination of the alumina such as the transition alumina into alpha alumina may be carried out in this reactor, it may also, for example, be referred to as a calciner. A variety of known reactors can provide suitable conditions, the selection of which for a particular process can be made by a person skilled in the art.

For example, the processes can be carried out in a fluidized bed reactor. For example, the process can be carried out in a rotary kiln reactor. For example, the process can be carried out in a pendulum kiln reactor. For example, the process can be carried out in a tubular oven.

For example, the heating of the alumina can be carried out in a fluidized bed reactor. For example, the heating of the alumina can be carried out in a rotary kiln reactor. For example, the heating of the alumina can be carried out in a tunnel kiln reactor. For example, the heating of the alumina can be carried out in a roller hearth kiln reactor. For example, the heating of the alumina can be carried out in a shuttle kiln reactor.

For example, in order to decrease, for example, the contamination level in a product, the reactor can be heated indirectly. Alternatively, for example, it may be heated directly, for example, where it is not as important that the product α-Al₂O₃ or transition alumina has low amounts of contamination.

Accordingly, for example, the alumina can be heated indirectly. Alternatively, for example, the alumina can be heated directly.

For example, the particle size distribution D10 of the α-Al₂O₃ or transition alumina can be about 2 μm to about 8 μm or about 4 μm to about 5 μm.

For example, the particle size distribution D50 of the α-Al₂O₃ or transition alumina is about 10 μm to about 25 μm to about 15 μm to about 20 μm.

For example, the particle size distribution D90 of the α-Al₂O₃ or transition alumina is from about 35 μm to about 50 μm or about 40 μm to about 45 μm.

For example, the loose density of the α-Al₂O₃ or transition alumina can be less than about 1.0 g/mL, less than about 0.9 g/mL, less than about 0.8 g/mL less than about 0.7 g/mL, less than about 0.6 g/mL, less than about 0.5 g/mL, or less than about 0.4 g/mL.

For example, the loose density of the α-Al₂O₃ or transition alumina can be about 0.2 to about 0.7 g/mL, about 0.3 to about 0.6 g/mL or about 0.4 to about 0.5 g/mL.

For example, the α-Al₂O₃ or transition alumina can be high purity alumina (HPA).

For example, the steam can be introduced into the process as saturated steam or water. For example, the calcination of the alumina can be carried out in the presence of superheated steam.

For example, calcination can be carried out in a single reactor rather than two consecutive ones may, for example, to eliminate the necessity of a second decomposer and therefore decrease the capital cost to design, manufacture and operate the equipment.

For example, calcination can also be carried out in a single reactor. For example, in a single reactor, the calcination can be carried out in a single step or in more than one step. According to another example, the calcination can be carried out in two different calcinators or in a plurality thereof.

For example calcination can be carried in more than one step.

For example, calcination can be carried in more than one calcinator.

The processes of the present disclosure may be used for obtaining alpha alumina or transition alumina using a variety of sources of alumina (e.g. transition alumina such as χ-Al₂O₃, κ-Al₂O₃, γ-Al₂O₃, θ-Al₂O₃, δ-Al₂O₃, η-Al₂O₃, ρ-Al₂O₃ or combinations thereof) as feed for a calciner. For example, aluminum chloride hexahydrate (AlCl₃.6H₂O or “ACH”) crystals (obtained, for example, from an acid-based process to digest silica rich alumina ore) can be thermally decomposed, for example, in the presence or not of steam and optionally the at least one gas (for example the at least one gas can be chosen from air, argon, nitrogen, carbon dioxide, hydrogen and hydrochloric acid), to obtain γ-Al₂O₃ which may be heated in the processes of the present disclosure to obtain the χ-Al₂O₃.

Accordingly, for example, the alumina can comprise amorphous alumina, transition alumina or combinations thereof. For example, the alumina can consist essentially of amorphous alumina, transition alumina or combinations thereof. For example, the alumina can comprise transition alumina. For example, the alumina can consist essentially of transition alumina.

For example, the transition alumina can comprise χ-Al₂O₃, κ-Al₂O₃, γ-Al₂O₃, θ-Al₂O₃, δ-Al₂O₃, η-Al₂O₃, ρ-Al₂O₃ or combinations thereof. For example, the transition alumina can consist essentially of χ-Al₂O₃, κ-Al₂O₃, γ-Al₂O₃, θ-Al₂O₃, δ-Al₂O₃, η-Al₂O₃, ρ-Al₂O₃ or combinations thereof. For example, the transition alumina can comprise γ-Al₂O₃. For example, the transition alumina can consist essentially of γ-Al₂O₃.

For example, the γ-Al₂O₃ can be obtained by a process for decomposing AlCl₃.6H₂O into γ-Al₂O₃, the process comprising heating the AlCl₃.6H₂O at a temperature of about 600° C. to about 800° C. in the presence of steam and optionally the at least one gas (for example the at least one gas can be chosen from air, argon, nitrogen, carbon dioxide, hydrogen and hydrochloric acid), under conditions suitable to obtain the γ-Al₂O₃. For example, the process for decomposing AlCl₃.6H₂O into γ-Al₂O₃ and the process for converting alumina into α-Al₂O₃ or transition alumina can be carried out in a single reactor.

For example, the γ-Al₂O₃ can be obtained by decomposing AlCl₃.6H₂O into γ-Al₂O₃, the process comprising heating the AlCl₃.6H₂O at a temperature of about 600° C. to about 800° C. in the presence of steam and optionally the at least one gas chosen (for example the at least one gas can be chosen from air, argon, nitrogen, carbon dioxide, hydrogen and hydrochloric acid), under conditions suitable to obtain the γ-Al₂O₃.

For example, the AlCl₃.6H₂O may be heated optionally in the presence of air. For example, the air may be delivered to a reaction chamber in which the AlCl₃.6H₂O is heated via an air stream. It will be appreciated by a person skilled in the art that AlCl₃.6H₂O crystals may contain organics, for example, organics derived from an ore used to prepare the AlCl₃.6H₂O crystals. The optional air may be useful to oxidize such organic molecules. The optional air may also be used to dilute the steam concentration and thereby may inhibit or prevent the condensation of steam at an inlet and/or an outlet of the reactor. The relative concentration of air and steam may, for example, alter other conditions useful for the decomposition reaction. For example, a process wherein higher amounts of air are used to dilute the steam will typically use higher temperatures and/or longer residence times.

For example, the at least one gas can be chosen from air, argon, nitrogen, carbon dioxide, hydrogen and hydrochloric acid.

For example, the steam can be present in an amount that is at least a catalytic amount. For example, the steam can be present in an amount of at least about 5 wt %. For example, the steam can be present in an amount of at least about 6 wt %. For example, the steam can be present in an amount of at least about 10 wt %. For example, the steam can be present in an amount of at least about 15 wt %. For example, the steam can be present in an amount of at least about 25 wt %. For example, the steam can be present in an amount of at least about 35 wt %. For example, the steam can be present in an amount of at least about 45 wt %. For example, the steam can be present in an amount of at least about 55 wt %. For example, the steam can be present in an amount of at least about 65 wt %. For example, the steam can be present in an amount of at least about 70 wt %. For example, the steam can be present in an amount of at least about 75 wt %. For example, the steam can be present in an amount of at least about 80 wt %. For example, the steam can be present in an amount of at least about 85 wt %. For example, the steam can be present in an amount of at least about 90 wt %. For example, the steam can be present in an amount of at least about 95 wt %. For example, the steam can be present in an amount of about 5 wt % to about 95%.

For example, the AlCl₃.6H₂O can be heated in the presence of steam and the at least one gas. For example, the steam can be present in an amount of about 80 wt % to about 90 wt % and the at least one gas can be present in an amount of about 10 wt % to about 20 wt %, based on the total weight of the steam and the at the least one gas. For example, the steam can be present in an amount of about 82 wt % to about 88 wt % and the at least one gas can be present in an amount of about 12 wt % to about 18 wt %, based on the total weight of the steam and the at least one gas. For example, the steam can be present in an amount of about 85 wt % and the at least one gas can be present in an amount of about 15 wt %, based on the total weight of the at least one gas.

In the studies of the present disclosure, it was observed that decomposition of AlCl₃.6H₂O into γ-Al₂O₃ in the presence of steam and optionally air in a single step reactor may be achieved at temperatures as low as about 600° C. At a temperature of about 600° C., the reaction takes a longer time to reach completion than when the AlCl₃.6H₂O is heated at higher temperatures. For example, it is possible to heat the AlCl₃.6H₂O at a temperature of at least about 700° C. It will be appreciated by a person skilled in the art that heating the AlCl₃.6H₂O at elevated temperatures, for example above about 800° C., will typically use more energy than heating at lower temperatures.

Accordingly, for example, the AlCl₃.6H₂O can be heated at a temperature of about 650° C. to about 800° C. For example, the AlCl₃.6H₂O can be heated at a temperature of about 700° C. to about 800° C. For example, the AlCl₃.6H₂O can be heated at a temperature of about 700° C. to about 750° C. For example, the AlCl₃.6H₂O can be heated at a temperature of about 700° C.

For example, the AlCl₃.6H₂O can be heated at the temperature for a time of less than about 5 hours. For example, the AlCl₃.6H₂O can be heated at the temperature for a time of less than about 4 hours. For example, the AlCl₃.6H₂O can be heated at the temperature for a time of less than about 3 hours. For example, the AlCl₃.6H₂O can be heated at the temperature for a time of less than about 2 hours. For example, the AlCl₃.6H₂O can be heated at the temperature for a time of less than about 1 hour. For example, the AlCl₃.6H₂O can be heated at the temperature for a time of less than about 45 minutes. For example, the AlCl₃.6H₂O can be heated at the temperature for a time of less than about 40 minutes. For example, the AlCl₃.6H₂O can be heated at the temperature for a time of less than about 30 minutes.

For example, the steam can be provided at a rate of from about 0.0001 grams to about 2 grams of steam per gram of AlCl₃.6H₂O, per minute. For example, the steam can be provided at a rate of from about 0.001 grams to about 2 grams of steam per gram of AlCl₃.6H₂O, per minute. For example, the steam can be provided at a rate of from about 0.01 grams to about 2 grams of steam per gram of AlCl₃.6H₂O, per minute. For example, the steam can be provided at a rate of from about 0.05 grams to about 1 gram of steam per gram of AlCl₃.6H₂O, per minute. For example, the steam can be provided at a rate of from about 0.05 grams to about 0.5 grams of steam per gram of AlCl₃.6H₂O, per minute.

For example, the steam can be introduced at a ratio of mass of steam introduced to mass of γ-Al₂O₃ obtained of about 0.001:1 to about 100:1. For example, the steam can be introduced at a ratio of mass of steam introduced to mass of γ-Al₂O₃ obtained of about 0.01:1 to about 100:1. For example, the steam can be introduced at a ratio of mass of steam introduced to mass of γ-Al₂O₃ obtained of about 0.1:1 to about 100:1. For example, the steam can be introduced at a ratio of mass of steam introduced to mass of γ-Al₂O₃ obtained of about 1:1 to about 50:1. For example, the steam can be introduced at a ratio of mass of steam introduced to mass of γ-Al₂O₃ obtained of about 10:1 to about 50:1. For example, the steam can be introduced at a ratio of mass of steam introduced to mass of γ-Al₂O₃ obtained of about 10:1 to about 30:1.

Alternatively, for example, the heating of the AlCl₃.6H₂O at the temperature can be carried out in a chamber in the presence of the steam and optionally the at least one gas, and the steam and optionally the at least one gas can be released from the chamber after the γ-Al₂O₃ is obtained. For example, the heating of the AlCl₃.6H₂O at the temperature can be carried out in a chamber, the steam and optionally the at least one gas can be introduced into the chamber prior to the heating at the temperature, and the steam and optionally the at least one gas can be released from the chamber after the γ-Al₂O₃ is obtained.

For example, the decomposition of the AlCl₃.6H₂O into the γ-Al₂O₃ can be carried out in the presence of superheated steam. For example, the steam can be introduced into the process as saturated steam, water or a mixture thereof.

In the processes of the present disclosure, heating the reactor indirectly will typically lead to higher concentrations of HCl in the off gas and may therefore reduce contamination of the product γ-Al₂O₃. However, it is also useful to heat the reactor directly, for example, where it is not as important that the product γ-Al₂O₃ has low amounts of contamination.

Accordingly, for example, the AlCl₃.6H₂O can be heated indirectly. Alternatively, for example, the AlCl₃.6H₂O can be heated directly.

For example, the decomposition of AlCl₃.6H₂O into γ-Al₂O₃ can be carried out in a single heating step in a single reactor. This may, for example, decrease capital cost for design and manufacture.

Accordingly, for example, the decomposition of the AlCl₃.6H₂O to the γ-Al₂O₃ can be carried out in a single step.

For example, the thermal decomposition of AlCl₃.6H₂O to obtain γ-Al₂O₃ can be carried out in any type of reactor that can provide suitable conditions for heating the AlCl₃.6H₂O at a desired temperature, for example a temperature of about 600° C. to about 800° C., in the presence of steam and optionally the at least one gas to obtain the γ-Al₂O₃. A variety of known reactors can provide suitable conditions, the selection of which for a particular process can be made by a person skilled in the art.

For example, the process can be carried out in a fluidized bed reactor. For example, the process can be carried out in a rotary kiln reactor. For example, the process can be carried out in a pendulum kiln reactor. For example, the process can be carried out in a tubular oven.

The selection of a suitable source of AlCl₃.6H₂O for the process of the present disclosure can be made by a person skilled in the art.

For example, the AlCl₃.6H₂O and/or the alumina can be derived from an aluminum-containing material.

The aluminum-containing material can be for example chosen from aluminum-containing ores (such as clays, argillite, mudstone, beryl, cryolite, garnet, spinel, bauxite, kaolin, nepheline or mixtures thereof can be used). The aluminum-containing material can also be an industrial aluminum-containing material such as slag, red mud or fly ashes.

For example, the aluminum-containing material can be SGA, ACH, aluminum, bauxite, aluminum hydroxide, red mud, fly ashes etc.

For example, the AlCl₃.6H₂O can be derived from an aluminum-containing ore.

For example, the aluminum-containing ore can be a silica-rich, aluminum-containing ore. For example, the aluminum-containing ore can be an aluminosilicate ore (such as clays, argilite), bauxite, kaolin, nepheline, mudstone, beryl, garnet, spinel. For example, the AlCl₃.6H₂O and/or the alumina can be derived from the aluminum-containing ore by an acid-based process. For example, the AlCl₃.6H₂O can be obtained by dissolving of aluminum, alumina or aluminum hydroxide in HCl. For example, the AlCl₃.6H₂O can have a particle size distribution D50 of about 100 μm to about 1000 μm or of about 100 μm to about 5000 μm. For example, the AlCl₃.6H₂O can have a particle size distribution D50 of about 200 μm to about 800 μm. For example, the AlCl₃.6H₂O can have a particle size distribution D50 of about 300 μm to about 700 μm.ln the studies of the present disclosure, heating AlCl₃.6H₂O at temperatures of about 600° C. to about 800° C. in the presence of steam and optionally the at least one gas was found to result in the production of γ-Al₂O₃ having a significantly lower residual chlorine content than the γ-Al₂O₃ obtained by heating AlCl₃.6H₂O at this temperature range in the presence of the at least one gas (without addition of steam) or nitrogen. γ-Al₂O₃ having a lower level of impurities may be useful in processes for producing smelter grade alumina and processes for producing high purity alumina, as well as fused aluminas and specialty aluminas.

For example, the γ-Al₂O₃ can contain less than about 1500 ppm by weight chlorine. For example, the γ-Al₂O₃ can contain less than about 1000 ppm by weight chlorine. For example, the γ-Al₂O₃ can contain less than about 750 ppm by weight chlorine. For example, the γ-Al₂O₃ can contain less than about 500 ppm by weight chlorine. For example, the γ-Al₂O₃ can contain less than about 400 ppm by weight chlorine. For example, the γ-Al₂O₃ can contain less than about 200 ppm by weight chlorine. For example, the γ-Al₂O₃ can contain less than about 100 ppm by weight chlorine. For example, the γ-Al₂O₃ can contain less than 50 ppm by weight chlorine.

It will be appreciated by a person skilled in the art that the γ-Al₂O₃ obtained from the processes of the present disclosure may be suitable for various uses, for example, uses wherein a low residual chlorine content is useful. For example, the γ-Al₂O₃ can be suitable for use in a process for preparing smelter grade alumina (SGA). For example, the γ-Al₂O₃ can be smelter grade alumina (SGA). For example, the γ-Al₂O₃ can be suitable for use in a process for calcining the γ-Al₂O₃ to obtain high purity alumina (HPA). For example, the γ-Al₂O₃ can also be suitable for use in a process for converting the γ-Al₂O₃ to obtain specialty alumina, tabular alumina, calcined alumina or fused alumina.

The off gases released by the processes of the present disclosure mainly comprise hydrogen chloride and steam.

For example, the off gases can be recycled and reused in the aluminum chlorides extraction process and/or the AlCl₃.6H₂O crystals extraction and purification process. For example, off gases containing chlorine (for example in the form of HCl) can be condensed/absorbed and reused in the alumina preparation plant either at the leaching/digestion or at ACH precipitation, crystallization, or preparation thereof.

Accordingly, for example, the process can release an off gas comprising hydrogen chloride and steam. For example, the composition of the off gas can be substantially hydrogen chloride and steam. It will be appreciated by a person skilled in the art that hydrogen chloride gas and steam are easily condensed and/or absorbed by water. Accordingly, for example, the process can further comprise treating the off gas in a scrubbing unit, wherein in the scrubbing unit, the hydrogen chloride and steam are condensed and/or absorbed by water and/or recycling and reusing the off gas in the aluminum chloride extraction process and/or the AlCl₃.6H₂O crystals extraction and purification process. For example, off gases containing chlorine (for example in the form of HCl) can be condensed/absorbed and reused in the alumina preparation plant either at the leaching/digestion or at ACH precipitation, crystallization, or preparation thereof.

For example, the processes of the present disclosure can be useful for preparing transition alumina, SGA, HPA, fused alumina, transition alumina, tabular alumina, calcined alumina, ultra-pure alumina or specialty alumina.

For example, the processes of the present disclosure can further comprise treating the γ-Al₂O₃ or the transition alumina in order to obtain HPA, fused alumina, transition alumina, tabular alumina, calcined alumina, ultra-pure alumina or specialty alumina. Such treatments can comprise, for example, heating (such as calcination, plasma torch treatment), forming (such as pressure, compacting, rolling, grinding, compressing, spheronization, pelletization, densification).

For example, such fused alumina and specialty alumina can be used for various applications.

The following examples are non-limitative and are used to better exemplify the processes of the present disclosure:

### EXAMPLES

### Example 1

Several experiments have been carried out at the bench scale. Decomposition was carried out inside a tube furnace under nitrogen, air, steam and a mixture of air and steam environments. The residual chlorine content was measured and the crystalline structure was investigated (see Table 1).

The tools to run the experiments were two tube furnaces, a rotary kiln, a scrubbing unit, a nitrogen cylinder, a compressed air cylinder, a pH meter, and a steam generator.

The tools/techniques used to analyze the samples were inductively coupled plasma mass spectrometry (ICP-MS).

TABLE 1

| | Residual chlorine content wt ppm (alumina phase) | | | | | | | |
|---|---|---|---|---|---|---|---|---|
| Temperature | Nitrogen | | Air | | Steam | | Air + steam | |
| 500 | 36950 | (amorphous) | 27800 | (amorphous) | 14000 | (amorphous) | 14925 | (amorphous) |
| 600 | 30700 | (amorphous) | 23400 | (amorphous) | 500 | (γ) | 320 | (γ) |
| 700 | 30100 | (amorphous) | 17100 | (amorphous) | 640 | (γ) | 310 | (γ) |

| | | | | | | | |
|---|---|---|---|---|---|---|---|
| 800 | 19750 | (γ) | 1900 | (γ) | 560 | (γ) | — |
| 875 | 17110 | (γ) | 1300 | (γ) | 410 | (γ) | — |

The residence time at the above temperatures depended on the temperature. In each of the trials, over an about 10 hour period, the samples were heated at a rate of 240° C./hour until the desired temperature was reached, the temperature was substantially maintained at this temperature for the relevant time then cooled at a rate of 180° C./hour until room temperature was reached. For example, residence time at 500° C. was about 6 hours, residence time at 600° C. was about 5.5 hours, residence time at 700° C. was about 5 hours, and residence time at 800° C. was about 4 hours. As can be seen from the results in Table 1, the reaction temperature can be decreased as low as 600° C. The reaction at 600° C. takes a long time and, therefore, it is useful to carry out the process at ≧700° C. The content of residual chlorine in the alumina produced in the process with a steam environment is significantly smaller than the residual chlorine content of the alumina produced in the processes with an air or nitrogen environment.

The operation of the decomposer at high temperatures and the content of unreacted ACH are two concerns in the known methods for the production of transition alumina or alumina from ACH crystals.

Processes comprising the thermal decomposition of ACH crystals in a steam or steam and air environment at a reduced temperature are disclosed herein. The complete decomposition of ACH crystals occurs in a single reactor at a lower temperature than for other types of atmospheric media. Another advantage of the processes of the present disclosure is that the off gas contains a negligible amount of inert gas which may simplify the design of a scrubbing section associated to the decomposer or allow for the off gas to be recycled and reused in the aluminum chloride extraction process and/or the AlCl₃.6H₂O crystals extraction and purification process. For example, off gases containing chlorine (for example in the form of HCl) can be condensed/absorbed and reused in the alumina preparation plant either at the leaching/digestion or at ACH precipitation, crysrtallization, or preparation thereof.

The complete decomposition occurs at reduced temperatures (as low as 600° C. compared to 900° C. typically) and unreacted ACH content decreases to less than a few hundred ppm. As the chlorine content drops to a very small level, it may, for example, reduce the potential corrosion which may occur in subsequent equipment.

Instead of reaction in the steam environment, known processes for the preparation of alumina may comprise the decomposition of ACH crystals carried out in the presence of other gases such as air, hydrogen or nitrogen. The use of hydrogen may, for example increase the operational cost due to consumption of hydrogen as well as treatment of the off gas. Its usage is also, for example associated with stricter codes and standards for the process and equipment design which may, for example increase the capital cost and/or the potential safety issues. The decomposition reaction in an environment of air or nitrogen occurs at higher temperatures (at least about 800° C.) and the content of residual chlorine in the product may, for example be relatively higher than the chlorine content in alumina which is produced in the presence of steam. To produce alumina which contains a low content of residual chlorine, in an air environment, the reaction uses very high temperatures (about 900-1000° C.). A high level of residual chlorine content may, for example result in corrosion inside the subsequent equipment over a long time period if the process is operated at high temperatures (for example inside a calciner to obtain corundum). Residual chlorine is also problematic, for example when the alumina is used in the Hall process for aluminum metal production. In addition, a low chlorine content may, for example be desired for high quality alumina refractories, fused alumina or other such uses of alumina.

### Example 2

ACH crystals were analyzed by thermogravimetric analysis (TGA) and by differential scanning calorimetry (DSC) under an argon atmosphere, heated at a rate of 10.0° C. per minute as compared to a steam environment under the same conditions. As can be seen from FIG. 1, the temperature for the transition to both γ-Al₂O₃ and α-Al₂O₃ occurs at a lower temperature for the ACH crystals heated under a steam atmosphere (γ-Al₂O₃: peak at 771° C.; α-Al₂O₃: peak at 1188° C.) in comparison to the ACH crystals heated under an argon atmosphere (γ-Al₂O₃: peak at 862° C.; α-Al₂O₃: peak at 1243° C.) at the same heating rate.

ACH crystals were also analyzed by TGA under a steam atmosphere, heating at a rate of 10° C./minute. FIG. 2 shows a comparison between the TGA curves for ACH crystals heated under the steam atmosphere to ACH crystals heated under an argon atmosphere under similar conditions. FIG. 3 shows an enlarged version of the area indicated with a circle in FIG. 2.

As can be seen in FIG. 3, the ACH crystals heated under an argon atmosphere show additional weight loss (about 3-4 wt %) in a temperature region wherein the ACH crystals heated under a steam atmosphere do not show weight loss. While not wishing to be limited by theory, the weight loss in this region of the ACH crystals heated under an argon atmosphere is chlorine which was present before loss from the sample in the form of polyaluminum chlorides. The end of the decomposition for the ACH crystals heated under a steam atmosphere was at about 750° C. whereas the end of the decomposition for the ACH crystals heated under an argon atmosphere was at about 1200° C. The experiments also showed that under a steam atmosphere the “drastic loss of mass” during the transition from the γ-Al₂O₃ phase is not observed (see the loss of residual chlorine when decomposition is carried out under an argon atmosphere).

### Example 3

About 20 grams of amorphous alumina was heated in a crucible in a furnace at various temperatures. FIG. 4 shows various results obtained while sweeping with nitrogen gas, air, steam or a combination of steam and air. Steam has been introduced at a rate of 3.62±0.45 grams/minute.

FIG. 4 shows the results for the experiments with nitrogen gas. As can be seen in FIG. 4, the amorphous alumina used had a chlorine content of about 3.8 wt %. After the amorphous alumina was heated for the high residence time used for the temperature of 500° C. there was still between 3-4 wt % chlorine present in the sample. As the temperature increased, the chlorine content after heating decreased but was still significant for the temperature of 900° C. Proper granular flow may help to increase the capacity but not the chlorine content.

FIG. 4 also shows the results for the experiments with air compared to the results of the experiments with nitrogen gas. As can be seen in FIG. 4, the amorphous alumina for the experiments with air had a chlorine content of about 3.5 wt %. In comparison to the experiments conducted with nitrogen, the samples heated with air had a lower chlorine content. After heating the amorphous alumina at a temperature of 800° C. while sweeping with air, the chlorine content was 2000 ppm by weight (0.2 wt %). After heating the amorphous alumina at a temperature of 1200° C. while sweeping with air, the chlorine content was less than 150 ppm by weight. FIG. 4 also shows the results for the experiments with steam compared to the results of the experiments with air and nitrogen gas. As can be seen in FIG. 4, the amorphous alumina for the experiments with air had a chlorine content of about 3.2 wt %. In comparison to the experiments conducted with nitrogen or air, the samples heated with steam had a lower chlorine content. For example, the presence of steam decreases the chlorine content to 500 ppm by weight (0.05 wt %) after heating at a temperature of 600° C.

FIG. 4 shows the results for the experiments with steam and air (air: 15±1 wt %) compared to the results of the experiments with air, nitrogen gas and steam (without air). In comparison to the experiments conducted with nitrogen or air, the samples heated with steam and air had a lower chlorine content. For example, the presence of steam and air decreases the chlorine content to 300 ppm by weight (0.03 wt %) after heating at a temperature of 600° C.

FIG. 5 shows the results for the above-described experiments with steam compared to the results for the above-described experiments with air and nitrogen, labeled to indicate the results of crystalline structure analysis (XRD). As can be seen from FIG. 5, for the experiments with nitrogen, the sample remained amorphous after heating at 700° C. but after heating at 800° C. and 900° C., γ-Al₂O₃ was obtained. For the experiments with air, the sample remained amorphous after heating at 700° C. but after heating at 750° C., γ-Al₂O₃ was obtained. For the experiments with steam, the sample remained amorphous after heating at 500° C. but after heating at 600° C., γ-Al₂O₃ was obtained and after heating at 1200° C., sharp peaks corresponding to α-Al₂O₃ were observed.

### Example 4

ACH crystals were analyzed by differential scanning calorimetry (DSC) as described in Example 2, with the exception that the comparison was made between conditions under an argon atmosphere and conditions under an environment comprising argon and 6% of steam. As can be seen from FIG. 6, the temperature for the transition to both γ-Al₂O₃ and α-Al₂O₃ occurs at a lower temperature for the ACH crystals heated under an environment comprising 6% steam and argon (γ-Al₂O₃: peak at 776.5° C.; α-Al₂O₃: peak at 1169.5° C.) in comparison to the ACH crystals heated under an argon atmosphere (γ-Al₂O₃: peak at 862.3° C.; α-Al₂O₃: peak at 1243° C.) at the same heating rate.

### Example 5

Several experiments have been carried out regarding calcination of alumina (see Table 2). In these experiments, γ-Al₂O₃ (obtained from a process as previously discussed) was heated in a steam environment at different temperatures (950, 1000, 1025, 1050, 1075 and 1100° C.) to determine the temperature range at which the alpha structure of alumina is formed. The crystalline structure of the product of each experiment was obtained by an X-ray diffractometer.

The tools to run the experiments were two tube furnaces, a rotary kiln, a scrubbing unit, a nitrogen cylinder, a compressed air cylinder, a pH meter, and a steam generator.

The tools/techniques used to analyze the samples were inductively coupled plasma mass spectrometry (ICP-MS).

The obtained materials at reduced temperatures have been analyzed for their crystalline structure and PSD. The results are illustrated in Table 2. The formation of α-phase starts at 950° C. This implies that calcination in a fluid bed can be carried out at reduced temperatures.

TABLE 2

| Temperature | Particle size (μm) | | | |
|---|---|---|---|---|
| (C.) | D10 | D50 | D90 | Structure |
| 950 | 5.529 | 29.176 | 64.208 | Mixture of α and γ |
| 1000 | 5.077 | 25.994 | 58.402 | |
| 1025 | 5.103 | 24.398 | 54.918 | α + minor amount of |
| | | | | transient alumina |
| 1050 | 5.260 | 26.097 | 57.788 | α |
| 1075 | 5.022 | 22.842 | 50.351 | α |
| 1100 | 4.516 | 24.042 | 55.717 | α |

The observed loose densities were about 0.3 to about 0.6 g/mL.

### Example 6

In addition, the effect of the concentration of steam in the environment of the reactor was studied (see FIG. 7). As it can be seen, even with a considerably lower concentration of steam, the processes are quite efficient and allow for considerably lowering the temperature for the transition to α-Al₂O₃.

It was observed that the alpha structure of aluminum was obtained at a temperature as low as about 950° C. in a steam environment. It was observed that when the amount of steam is decreased, the calcination temperature increases to about 1100° C.

The formation of alpha alumina carried out in air or inert gas (such as nitrogen) environments, happens with a kinetics of reaction that is not as fast as for environments comprising steam having the same processing conditions. This means that the calcination for processes without steam use a higher temperature than processes with steam at the same residence time. Alternatively, the same temperature may be used but this is at the expense of using a longer time.

While a description was made with particular reference to the specific embodiments, it will be understood that numerous modifications thereto will appear to those skilled in the art. Accordingly, the above description and accompanying drawings should be taken as specific examples and not in a limiting sense.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

What is claimed is:

1. A process for converting alumina into α-Al₂O₃ or transition alumina, said process comprising heating said alumina at a temperature of about 950° C. to about 1150° C. in the presence of steam and optionally at least one gas chosen from air, argon, nitrogen, carbon dioxide, hydrogen and hydrochloric acid, under conditions suitable to obtain said α-Al₂O₃ or transition alumina.

2. The process of claim 1, wherein said alumina is heated at a temperature of about 950° C. to about 1100° C.

3. The process of claim 1, wherein said alumina is heated at a temperature of about 1100° C. to about 1150° C.

4. The process of claim 1, wherein said alumina is heated at a temperature of about 1050° C. to about 1080° C.

5. The process of any one of claims 1 to 4, wherein said alumina is heated at said temperature for less than about 10 hours.

6. The process of any one of claims 1 to 4, wherein said alumina is heated at said temperature for less than about 8 hours.

7. The process of any one of claims 1 to 4, wherein said alumina is heated at said temperature for less than about 6 hours.

8. The process of any one of claims 1 to 4, wherein said alumina is heated at said temperature for less than about 4 hours.

9. The process of any one of claims 1 to 4, wherein said alumina is heated at said temperature for less than about 3 hours.

10. The process of any one of claims 1 to 4, wherein said alumina is heated at said temperature for less than about 2 hours.

11. The process of any one of claims 1 to 4, wherein said alumina is heated at said temperature for less than about 1 hour.

12. The process of any one of claims 1 to 4, wherein said alumina is heated at said temperature for about 1 hour to about 4 hours.

13. The process of any one of claims 1 to 4, wherein said alumina is heated at said temperature for about 1 hour to about 2 hours.

14. The process of any one of claims 1 to 13, wherein said steam is provided at a rate of about 0.001 gram to about 20 grams of steam per minute per gram of alumina.

15. The process of any one of claims 1 to 13, wherein said steam is provided at a rate of about 0.01 gram to about 20 grams of steam per minute per gram of alumina.

16. The process of any one of claims 1 to 13, wherein said steam is provided at a rate of about 0.1 gram to about 20 grams of steam per minute per gram of alumina.

17. The process of any one of claims 1 to 13, wherein said steam is provided at a rate of about 1 gram to about 10 grams of steam per minute per gram of alumina.

18. The process of any one of claims 1 to 13, wherein said steam is provided at a rate of about 0.05 gram to about 5 grams of steam per minute per gram of alumina.

19. The process of any one of claims 1 to 13, wherein said steam is provided at a rate of about 0.1 grams to about 1 gram of steam per minute per gram of alumina.

20. The process of any one of claims 1 to 13, wherein said steam is provided at a rate of about 0.15 gram to about 0.5 gram of steam per minute per gram of alumina.

21. The process of any one of claims 1 to 13, wherein said steam is provided at a rate of about 0.2 gram to about 0.3 gram of steam per minute per gram of alumina.

22. The process of any one of claims 1 to 21, wherein said heating of said alumina at said temperature is carried out in a chamber in the presence of said steam and optionally said at least one gas chosen from air, argon, nitrogen, carbon dioxide and hydrogen and hydrochloric acid, and said steam and optionally said at least one gas chosen from air, argon, nitrogen, carbon dioxide, hydrogen and hydrochloric acid are released from said chamber after said α-Al₂O₃ or transition alumina is obtained.

23. The process of any one of claims 1 to 22, wherein said steam is present in at least a catalytic amount.

24. The process of any one of claims 1 to 22, wherein said steam is present in an amount of at least about 5 wt %.

25. The process of any one of claims 1 to 22, wherein said steam is present in an amount of at least about 15 wt %.

26. The process of any one of claims 1 to 22, wherein said steam is present in an amount of at least about 25 wt %.

27. The process of any one of claims 1 to 22, wherein said steam is present in an amount of at least about 35 wt %.

28. The process of any one of claims 1 to 22, wherein said steam is present in an amount of at least about 45 wt %.

29. The process of any one of claims 1 to 22, wherein said steam is present in an amount of at least about 55 wt %.

30. The process of any one of claims 1 to 22, wherein said steam is present in an amount of at least about 60 wt %.

31. The process of any one of claims 1 to 22, wherein said steam is present in an amount of at least about 65 wt %.

32. The process of any one of claims 1 to 22, wherein said steam is present in an amount of at least about 70 wt %.

33. The process of any one of claims 1 to 22, wherein said steam is present in an amount of at least about 75 wt %.

34. The process of any one of claims 1 to 22, wherein said steam is present in an amount of at least about 80 wt %.

35. The process of any one of claims 1 to 22, wherein said steam is present in an amount of at least about 85 wt %.

36. The process of any one of claims 1 to 35, wherein said alumina is heated in the presence of steam and said at least one gas chosen from air, argon, nitrogen, carbon dioxide, hydrogen and hydrochloric acid.

37. The process of claim 36, wherein said steam is present in an amount of about 80 wt % to about 90 wt % and said at least one gas chosen from air, argon, nitrogen, carbon dioxide, hydrogen and hydrochloric acid is present in an amount of about 10 wt % to about 20 wt %, based on the total weight of said steam and said at least one gas chosen from air, argon, nitrogen, carbon dioxide, hydrogen and hydrochloric acid.

38. The process of claim 36, wherein said steam is present in an amount of about 82 wt % to about 88 wt % and said at least one gas chosen from air, argon, nitrogen, carbon dioxide, hydrogen and hydrochloric acid is present in an amount of about 12 wt % to about 18 wt %, based on the total weight of said steam and said at least one gas chosen from air, argon, nitrogen, carbon dioxide, hydrogen and hydrochloric acid.

39. The process of claim 36, wherein said steam is present in an amount of about 85 wt % and said air is present in an amount of about 15 wt %, based on the total weight of said steam and said at least one gas chosen from air, argon, nitrogen, carbon dioxide, hydrogen and hydrochloric acid.

40. The process of any one of claims 1 to 39, wherein said process is carried out in a fluidized bed reactor.

41. The process of any one of claims 1 to 39, wherein said process is carried out in a rotary kiln reactor.

42. The process of any one of claims 1 to 39, wherein said process is carried out in a pendulum kiln reactor.

43. The process of any one of claims 1 to 39, wherein said process is carried out in a tubular oven.

44. The process of any one of claims 1 to 43, wherein said alumina is heated indirectly.

45. The process of any one of claims 1 to 43, wherein said alumina is heated directly.

46. The process of any one of claims 1 to 45, wherein the particle size distribution D10 of said α-Al₂O₃ or transition alumina is from about 2 μm to about 8 μm.

47. The process of any one of claims 1 to 45, wherein the particle size distribution D10 or transition alumina of said α-Al₂O₃ is from about 4 μm to about 5 μm.

48. The process of any one of claims 1 to 45, wherein the particle size distribution D50 of said α-Al₂O₃ or transition alumina is from about 10 μm to about 25 μm.

49. The process of any one of claims 1 to 45, wherein the particle size distribution D50 of said α-Al₂O₃ or transition alumina is from about 15 μm to about 20 μm.

50. The process of any one of claims 1 to 45, wherein the particle size distribution D90 of said α-Al₂O₃ or transition alumina is from about 35 μm to about 50 μm.

51. The process of any one of claims 1 to 45, wherein the particle size distribution D90 of said α-Al₂O₃ or transition alumina is from about 40 μm to about 45 μm.

52. The process of any one of claims 1 to 51, wherein the loose density of said α-Al₂O₃ or transition alumina is less than about 0.5 g/mL.

53. The process of any one of claims 1 to 51, wherein the loose density of said α-Al₂O₃ or transition alumina is less than about 0.4 g/mL.

54. The process of any one of claims 1 to 51, wherein the tap density of said α-Al₂O₃ or transition alumina is less than about 0.7 g/mL.

55. The process of any one of claims 1 to 51, wherein the tap density of said α-Al₂O₃ or transition alumina is less than about 0.6 g/mL.

56. The process of any one of claims 1 to 55, wherein said α-Al₂O₃ or transition alumina is high purity alumina (HPA).

57. The process of any one of claims 1 to 56, wherein said steam is introduced into said process as saturated steam or water.

58. The process of any one of claims 1 to 56, wherein said calcination of said alumina is carried out in the presence of superheated steam.

59. The process of any one of claims 1 to 58, wherein said alumina comprises amorphous alumina.

60. The process of any one of claims 1 to 58, wherein said alumina consists essentially of amorphous alumina.

61. The process of any one of claims 1 to 58, wherein said alumina comprises amorphous alumina, transition alumina or a combination thereof.

62. The process of any one of claims 1 to 58, wherein said alumina consists essentially of amorphous alumina, transition alumina or a combination thereof.

63. The process of any one of claims 1 to 58, wherein said alumina comprises transition alumina.

64. The process of any one of claims 1 to 58, wherein said alumina consists essentially of transition alumina.

65. The process of any one of claims 62 to 64, wherein said transition alumina comprises, χ-Al₂O₃, κ-Al₂O₃, γ-Al₂O₃, θ-Al₂O₃, δ-Al₂O₃, η-Al₂O₃, ρ-Al₂O₃ or combinations thereof.

66. The process of any one of claims 62 to 64, wherein said transition alumina consists essentially of χ-Al₂O₃, κ-Al₂O₃, γ-Al₂O₃, θ-Al₂O₃, δ-Al₂O₃, η-Al₂O₃, ρ-Al₂O₃ or combinations thereof.

67. The process of any one of claims 47 to 50, wherein said transition alumina comprises γ-Al₂O₃.

68. The process of any one of claims 47 to 50, wherein said transition alumina consists essentially of γ-Al₂O₃.

69. The process of claim 53 or 54, wherein said γ-Al₂O₃ is obtained by decomposing AlCl₃.6H₂O into γ-Al₂O₃, said process comprising heating said AlCl₃.6H₂O at a temperature of about 600° C. to about 800° C. in the presence of steam and optionally at least one gas chosen from air, argon, nitrogen, carbon dioxide, hydrogen and hydrochloric acid, under conditions suitable to obtain said γ-Al₂O₃.

70. The process of claim 69, wherein said AlCl₃.6H₂O has a particle size distribution D50 of about 100 μm to about 5000 μm.

71. The process of claim 69, wherein said AlCl₃.6H₂O has a particle size distribution D50 of about 100 μm to about 1000 μm.

72. The process of claim 69, wherein said AlCl₃.6H₂O has a particle size distribution D50 of about 200 μm to about 800 μm.

73. The process of claim 69, wherein said AlCl₃.6H₂O has a particle size distribution D50 of about 300 μm to about 700 μm.

74. The process of any one of claims 69 to 73, wherein said AlCl₃.6H₂O is heated at a temperature of about 650° C. to about 800° C.

75. The process of any one of claims 69 to 73, wherein said AlCl₃.6H₂O is heated at a temperature of about 700° C. to about 800° C.

76. The process of any one of claims 69 to 73, wherein said AlCl₃.6H₂O is heated at a temperature of about 700° C. to about 750° C.

77. The process of any one of claims 69 to 73, wherein said AlCl₃.6H₂O is heated at a temperature of about 700° C.

78. The process of any one of claims 69 to 77, wherein said AlCl₃.6H₂O is heated at said temperature for a time of less than about 5 hours.

79. The process of any one of claims 69 to 77, wherein said AlCl₃.6H₂O is heated at said temperature for a time of less than about 4 hours.

80. The process of any one of claims 69 to 77, wherein said AlCl₃.6H₂O is heated at said temperature for a time of less than about 3 hours.

81. The process of any one of claims 69 to 77, wherein said AlCl₃.6H₂O is heated at said temperature for a time of less than about 2 hours.

82. The process of any one of claims 69 to 77, wherein said AlCl₃.6H₂O is heated at said temperature for a time of less than about 1 hour.

83. The process of any one of claims 69 to 77, wherein said AlCl₃.6H₂O is heated at said temperature for a time of less than about 45 minutes.

84. The process of any one of claims 69 to 77, wherein said AlCl₃.6H₂O is heated at said temperature for a time of less than about 40 minutes.

85. The process of any one of claims 69 to 77, wherein said AlCl₃.6H₂O is heated at said temperature for a time of less than about 30 minutes.

86. The process of any one of claims 69 to 85, wherein said steam is provided at a rate of from about 0.0001 grams to about 2 grams of steam per gram of AlCl₃.6H₂O, per minute.

87. The process of any one of claims 69 to 85, wherein said steam is provided at a rate of from about 0.001 grams to about 2 grams of steam per gram of AlCl₃.6H₂O, per minute.

88. The process of any one of claims 69 to 85, wherein said steam is provided at a rate of from about 0.01 grams to about 2 grams of steam per gram of AlCl₃.6H₂O, per minute.

89. The process of any one of claims 69 to 85, wherein said steam is provided at a rate of from about 0.05 grams to about 1 gram of steam per gram of AlCl₃.6H₂O, per minute.

90. The process of any one of claims 69 to 85, wherein said steam is provided at a rate of from about 0.05 grams to about 0.5 grams of steam per gram of AlCl₃.6H₂O, per minute.

91. The process of any one of claims 69 to 85, wherein said steam is introduced at a ratio of mass of steam introduced to mass of γ-Al₂O₃ obtained of about 0.001:1 to about 100:1.

92. The process of any one of claims 69 to 85, wherein said steam is introduced at a ratio of mass of steam introduced to mass of γ-Al₂O₃ obtained of about 0.01:1 to about 100:1.

93. The process of any one of claims 69 to 85, wherein said steam is introduced at a ratio of mass of steam introduced to mass of γ-Al₂O₃ obtained of about 0.1:1 to about 100:1.

94. The process of any one of claims 69 to 85, wherein said steam is introduced at a ratio of mass of steam introduced to mass of γ-Al₂O₃ obtained of about 1:1 to about 50:1.

95. The process of any one of claims 69 to 85, wherein said steam is introduced at a ratio of mass of steam introduced to mass of γ-Al₂O₃ obtained of about 10:1 to about 50:1.

96. The process of any one of claims 69 to 85, wherein said steam is introduced at a ratio of mass of steam introduced to mass of γ-Al₂O₃ obtained of about 10:1 to about 30:1.

97. The process of any one of claims 69 to 96, wherein said heating of said AlCl₃.6H₂O at said temperature is carried out in a chamber in the presence of said steam and optionally said at least one gas chosen from air, argon, nitrogen, carbon dioxide, hydrogen and hydrochloric acid, and said steam and optionally said at least one gas chosen from air, argon, nitrogen, carbon dioxide, hydrogen and hydrochloric acid are released from said chamber after said γ-Al₂O₃ is obtained.

98. The process of any one of claims 69 to 96, wherein said heating of said AlCl₃.6H₂O at said temperature is carried out in a chamber, said steam and optionally said at least one gas chosen from air, argon, nitrogen, carbon dioxide, hydrogen and hydrochloric acid are introduced into said chamber prior to said heating at said temperature, and said steam and optionally said at least one gas chosen from air, argon, nitrogen, carbon dioxide, hydrogen and hydrochloric acid are released from said chamber after said γ-Al₂O₃ is obtained.

99. The process of any one of claims 69 to 98, wherein said steam is present in at least a catalytic amount.

100. The process of any one of claims 69 to 98, wherein said steam is present in an amount of at least about 5 wt %.

101. The process of any one of claims 69 to 98, wherein said steam is present in an amount of at least about 15 wt %.

102. The process of any one of claims 69 to 98, wherein said steam is present in an amount of at least about 25 wt %.

103. The process of any one of claims 69 to 98, wherein said steam is present in an amount of at least about 35 wt %.

104. The process of any one of claims 69 to 98, wherein said steam is present in an amount of at least about 45 wt %.

105. The process of any one of claims 69 to 98, wherein said steam is present in an amount of at least about 55 wt %.

106. The process of any one of claims 69 to 98, wherein said steam is present in an amount of at least about 60 wt %.

107. The process of any one of claims 69 to 98, wherein said steam is present in an amount of at least about 65 wt %.

108. The process of any one of claims 69 to 98, wherein said steam is present in an amount of at least about 70 wt %.

109. The process of any one of claims 69 to 98, wherein said steam is present in an amount of at least about 75 wt %.

110. The process of any one of claims 69 to 98, wherein said steam is present in an amount of at least about 80 wt %.

111. The process of any one of claims 69 to 98, wherein said steam is present in an amount of at least about 85 wt %.

112. The process of any one of claims 69 to 111, wherein said AlCl₃.6H₂O is heated in the presence of steam and said at least one gas chosen from air, argon, nitrogen, carbon dioxide, hydrogen and hydrochloric acid.

113. The process of claim 112, wherein said steam is present in an amount of about 80 wt % to about 90 wt % and said at least one gas chosen from air, argon, nitrogen, carbon dioxide, hydrogen and hydrochloric acid is present in an amount of about 10 wt % to about 20 wt %, based on the total weight of said steam and said at least one gas chosen from air, argon, nitrogen, carbon dioxide, hydrogen and hydrochloric acid.

114. The process of claim 112, wherein said steam is present in an amount of about 82 wt % to about 88 wt % and said at least one gas chosen from air, argon, nitrogen, carbon dioxide, hydrogen and hydrochloric acid is present in an amount of about 12 wt % to about 18 wt %, based on the total weight of said steam and said at least one gas chosen from air, argon, nitrogen, carbon dioxide, hydrogen and hydrochloric acid.

115. The process of claim 112, wherein said steam is present in an amount of about 85 wt % and said air is present in an amount of about 15 wt %, based on the total weight of said steam and said at least one gas chosen from air, argon, nitrogen, carbon dioxide, hydrogen and hydrochloric acid.

116. The process of any one of claims 69 to 115, wherein said process is carried out in a fluidized bed reactor.

117. The process of any one of claims 69 to 115, wherein said process is carried out in a rotary kiln reactor.

118. The process of any one of claims 69 to 115, wherein said process is carried out in a pendulum kiln reactor.

119. The process of any one of claims 69 to 115, wherein said process is carried out in a tubular oven.

120. The process of any one of claims 69 to 119, wherein said AlCl₃.6H₂O is heated indirectly.

121. The process of any one of claims 69 to 119, wherein said AlCl₃.6H₂O is heated directly.

122. The process of any one of claims 69 to 121, wherein said decomposition of said AlCl₃.6H₂O into said γ-Al₂O₃ is carried out in a single step or multiple steps.

123. The process of any one of claims 69 to 121, wherein said decomposition of said AlCl₃.6H₂O into said γ-Al₂O₃ is carried out in the presence of superheated steam.

124. The process of any one of claims 69 to 123, wherein said steam is introduced into said process as saturated steam or water.

125. The process of any one of claims 69 to 124, wherein said AlCl₃.6H₂O is derived from an aluminum-containing ore or an aluminum-containing material.

126. The process of claim 125, wherein said aluminum-containing ore is a silica-rich, aluminum-containing ore.

127. The process of claim 126, wherein said aluminum-containing ore is an aluminosilicate ore.

128. The process of any one of claims 125 to 127, wherein said AlCl₃.6H₂O is derived from said aluminum-containing ore by an acid-based process.

129. The process of claim 126, wherein AlCl₃.6H₂O is derived from an aluminum-containing material that is ACH or SGA.

130. The process of any one of claims 69 to 129, wherein said AlCl₃.6H₂O is obtained by dissolving aluminum, alumina and/or aluminum hydroxide into HCl.

131. The process of any one of claims 69 to 130, wherein said γ-Al₂O₃ contains less than about 1500 ppm by weight chlorine.

132. The process of any one of claims 69 to 130, wherein said γ-Al₂O₃ contains less than about 1000 ppm by weight chlorine.

133. The process of any one of claims 69 to 130, wherein said γ-Al₂O₃ contains less than about 750 ppm by weight chlorine.

134. The process of any one of claims 69 to 130, wherein said γ-Al₂O₃ contains less than about 500 ppm by weight chlorine.

135. The process of any one of claims 69 to 130, wherein said γ-Al₂O₃ contains less than about 400 ppm by weight chlorine.

136. The process of any one of claims 69 to 130, wherein said γ-Al₂O₃ contains less than about 200 ppm by weight chlorine.

137. The process of any one of claims 69 to 130, wherein said γ-Al₂O₃ contains less than about 100 ppm by weight chlorine.

138. The process of any one of claims 69 to 130, wherein said γ-Al₂O₃ contains less than about 50 ppm by weight chlorine.

139. The process of any one of claims 69 to 138, wherein said γ-Al₂O₃ is suitable for use in a process for preparing smelter grade alumina (SGA).

140. The process of any one of claims 69 to 138, wherein said γ-Al₂O₃ is smelter grade alumina (SGA).

141. The process of any one of claims 69 to 138, wherein said γ-Al₂O₃ is suitable for use in a process for calcining said γ-Al₂O₃ to obtain high purity alumina (HPA).

142. The process of any one of claims 69 to 138, wherein said γ-Al₂O₃ is suitable for use in the manufacture of specialty alumina or fused alumina for raw material in refractories, ceramics shapes, grinding wheels, sandpaper, blasting media, metal preparation, laminates, coatings, lapping, polishing or grinding.

143. The process of any one of claims 69 to 138, wherein the process further comprises treating γ-Al₂O₃ in order to obtain HPA, fused alumina, transition alumina, tabular alumina, calcined alumina, ultra-pure alumina or specialty alumina.

144. The process of any one of claims 69 to 138, wherein the process further comprises treating γ-Al₂O₃ in order to obtain HPA, fused alumina, transition alumina, tabular alumina, calcined alumina, ultra-pure alumina or specialty alumina, and wherein said treating comprises heating (such as calcination, plasma torch treatment), or forming (such as pressure, compacting, rolling, grinding, compressing, spheronization, pelletization, densification).

145. The process of any one of claims 69 to 144, wherein said process releases an off gas comprising hydrogen chloride and steam.

146. The process of claim 145, wherein said process further comprises treating said off gas in a scrubbing unit, wherein in said scrubbing unit, said hydrogen chloride and said steam are condensed and/or absorbed by water.

147. The process of claim 145, wherein off gases containing chlorine are condensed/absorbed and reused.

148. The process of claim 147, wherein said off gases are reused for leaching/digestion or for ACH precipitation, crystallization, or preparation thereof.

149. The process of any one of claims 145 to 148, wherein said process further comprises recycling hydrogen chloride so-produced.

150. The process of claim 149, wherein said process further comprises recycling hydrogen chloride so-produced and reusing it for the production of aluminum chloride.

151. The process of claim 149, wherein said hydrogen chloride is used for leaching a material and/or precipitating aluminum chloride.

152. A process for converting a first type of alumina into a second type of alumina, said process comprising heating said first type of alumina at a temperature of about 900° C. to about 1200° C. in the presence of steam and optionally at least one gas, under conditions suitable to obtain said second type alumina.

153. The process of claim 152, wherein said least one gas is chosen from air, argon, nitrogen, carbon dioxide, hydrogen and hydrochloric acid.

154. The process of claim 152 or 153, wherein said alumina is heated at a temperature of about 950° C. to about 1100° C.

155. The process of claim 152 or 153, wherein said alumina is heated at a temperature of about 1100° C. to about 1150° C.

156. The process of claim 152 or 153, wherein said alumina is heated at a temperature of about 1050° C. to about 1080° C.

157. The process of any one of claims 152 to 156, wherein said alumina is heated at said temperature for less than about 10 hours.

158. The process of any one of claims 152 to 156, wherein said alumina is heated at said temperature for less than about 8 hours.

159. The process of any one of claims 152 to 156, wherein said alumina is heated at said temperature for less than about 6 hours.

160. The process of any one of claims 152 to 156, wherein said alumina is heated at said temperature for less than about 4 hours.

161. The process of any one of claims 152 to 156, wherein said alumina is heated at said temperature for less than about 3 hours.

162. The process of any one of claims 152 to 156, wherein said alumina is heated at said temperature for less than about 2 hours.

163. The process of any one of claims 152 to 156, wherein said alumina is heated at said temperature for less than about 1 hour.

164. The process of any one of claims 152 to 156, wherein said alumina is heated at said temperature for about 1 hour to about 4 hours.

165. The process of any one of claims 152 to 156, wherein said alumina is heated at said temperature for about 1 hour to about 2 hours.

166. The process of any one of claims 152 to 165, wherein said steam is provided at a rate of about 0.001 gram to about 20 grams of steam per minute per gram of alumina.

167. The process of any one of claims 152 to 165, wherein said steam is provided at a rate of about 0.01 gram to about 20 grams of steam per minute per gram of alumina.

168. The process of any one of claims 152 to 165, wherein said steam is provided at a rate of about 0.1 gram to about 20 grams of steam per minute per gram of alumina.

169. The process of any one of claims 152 to 165, wherein said steam is provided at a rate of about 1 gram to about 10 grams of steam per minute per gram of alumina.

170. The process of any one of claims 152 to 165, wherein said steam is provided at a rate of about 0.05 gram to about 5 grams of steam per minute per gram of alumina.

171. The process of any one of claims 152 to 165, wherein said steam is provided at a rate of about 0.1 grams to about 1 gram of steam per minute per gram of alumina.

172. The process of any one of claims 152 to 165, wherein said steam is provided at a rate of about 0.15 gram to about 0.5 gram of steam per minute per gram of alumina.

173. The process of any one of claims 152 to 165, wherein said steam is provided at a rate of about 0.2 gram to about 0.3 gram of steam per minute per gram of alumina.

174. The process of any one of claims 152 to 173, wherein said heating of said alumina at said temperature is carried out in a chamber in the presence of said steam and optionally said at least one gas chosen from air, argon, nitrogen, carbon dioxide, hydrogen and hydrochloric acid, and said steam and optionally said at least one gas chosen from air, argon, nitrogen, carbon dioxide, hydrogen and hydrochloric acid are released from said chamber after said second type of alumina is obtained.

175. The process of any one of claims 152 to 174, wherein said steam is present in at least a catalytic amount.

176. The process of any one of claims 152 to 174, wherein said steam is present in an amount of at least about 5 wt %.

177. The process of any one of claims 152 to 174, wherein said steam is present in an amount of at least about 15 wt %.

178. The process of any one of claims 152 to 174, wherein said steam is present in an amount of at least about 25 wt %.

179. The process of any one of claims 152 to 174, wherein said steam is present in an amount of at least about 35 wt %.

180. The process of any one of claims 152 to 174, wherein said steam is present in an amount of at least about 45 wt %.

181. The process of any one of claims 152 to 174, wherein said steam is present in an amount of at least about 55 wt %.

182. The process of any one of claims 152 to 174, wherein said steam is present in an amount of at least about 60 wt %.

183. The process of any one of claims 152 to 174, wherein said steam is present in an amount of at least about 65 wt %.

184. The process of any one of claims 152 to 174, wherein said steam is present in an amount of at least about 70 wt %.

185. The process of any one of claims 152 to 174, wherein said steam is present in an amount of at least about 75 wt %.

186. The process of any one of claims 152 to 174, wherein said steam is present in an amount of at least about 80 wt %.

187. The process of any one of claims 152 to 174, wherein said steam is present in an amount of at least about 85 wt %.

188. The process of any one of claims 152 to 187, wherein said alumina is heated in the presence of steam and said at least one gas chosen from air, argon, nitrogen, carbon dioxide, hydrogen and hydrochloric acid.

189. The process of claim 188, wherein said steam is present in an amount of about 80 wt % to about 90 wt % and said at least one gas chosen from air, argon, nitrogen, carbon dioxide, hydrogen and hydrochloric acid is present in an amount of about 10 wt % to about 20 wt %, based on the total weight of said steam and said at least one gas chosen from air, argon, nitrogen, carbon dioxide, hydrogen and hydrochloric acid.

190. The process of claim 188, wherein said steam is present in an amount of about 82 wt % to about 88 wt % and said at least one gas chosen from air, argon, nitrogen, carbon dioxide, hydrogen and hydrochloric acid is present in an amount of about 12 wt % to about 18 wt %, based on the total weight of said steam and said at least one gas chosen from air, argon, nitrogen, carbon dioxide, hydrogen and hydrochloric acid.

191. The process of claim 188, wherein said steam is present in an amount of about 85 wt % and said air is present in an amount of about 15 wt %, based on the total weight of said steam and said at least one gas chosen from air, argon, nitrogen, carbon dioxide, hydrogen and hydrochloric acid.

192. The process of any one of claims 152 to 191, wherein said process is carried out in a fluidized bed reactor.

193. The process of any one of claims 152 to 191, wherein said process is carried out in a rotary kiln reactor.

194. The process of any one of claims 152 to 191, wherein said process is carried out in a pendulum kiln reactor.

195. The process of any one of claims 152 to 191, wherein said process is carried out in a tubular oven.

196. The process of any one of claims 152 to 195, wherein said AlCl₃.6H₂O is heated indirectly.

197. The process of any one of claims 152 to 195, wherein said AlCl₃.6H₂O is heated directly.

198. The process of any one of claims 152 to 197, wherein said steam is introduced into said process as saturated steam or water.

199. The process of any one of claims 152 to 197, wherein said calcination of said alumina is carried out in the presence of superheated steam.

200. The process of any one of claims 152 to 197, wherein said first type of alumina comprises amorphous alumina.

201. The process of any one of claims 152 to 197, wherein said first type of alumina consists essentially of amorphous alumina.

202. The process of any one of claims 152 to 197, wherein said first type of alumina comprises amorphous alumina, transition alumina or a combination thereof.

203. The process of any one of claims 152 to 197, wherein said first type of alumina consists essentially of amorphous alumina, transition alumina or a combination thereof.

204. The process of any one of claims 152 to 197, wherein said first type of alumina comprises transition alumina.

205. The process of any one of claims 152 to 197, wherein said first type of alumina consists essentially of transition alumina.

206. The process of any one of claims 202 to 205, wherein said transition alumina comprises, χ-Al₂O₃, κ-Al₂O₃, γ-Al₂O₃, θ-Al₂O₃, δ-Al₂O₃, η-Al₂O₃, ρ-Al₂O₃ or combinations thereof.

207. The process of any one of claims 202 to 205, wherein said transition alumina consists essentially of χ-Al₂O₃, κ-Al₂O₃, γ-Al₂O₃, θ-Al₂O₃, δ-Al₂O₃, η-Al₂O₃, ρ-Al₂O₃ or combinations thereof.

208. The process of any one of claims 202 to 205, wherein said transition alumina comprises γ-Al₂O₃.

209. The process of any one of claims 202 to 205, wherein said transition alumina consists essentially of γ-Al₂O₃.

210. The process of any one of claims 152 to 209, wherein said second type of alumina comprises amorphous alumina, transition alumina or a combination thereof.

211. The process of any one of claims 152 to 209, wherein said second type of alumina comprises transition alumina.

212. The process of any one of claims 152 to 209, wherein said second type of alumina consists essentially of transition alumina.

213. The process of any one of claims 210 to 212, wherein said transition alumina comprises, χ-Al₂O₃, κ-Al₂O₃, γ-Al₂O₃, θ-Al₂O₃, δ-Al₂O₃, η-Al₂O₃, ρ-Al₂O₃ or combinations thereof.

214. The process of any one of claims 210 to 212, wherein said transition alumina consists essentially of χ-Al₂O₃, κ-Al₂O₃, γ-Al₂O₃, θ-Al₂O₃, δ-Al₂O₃, η-Al₂O₃, ρ-Al₂O₃ or combinations thereof.

215. The process of any one of claims 210 to 212, wherein said transition alumina comprises γ-Al₂O₃.

216. The process of any one of claims 210 to 212, wherein said transition alumina consists essentially of γ-Al₂O₃.

217. The process of any one of claims 152 to 209, wherein said second type of alumina comprises α-Al₂O₃.

218. The process of any one of claims 152 to 209, wherein said second type of alumina consists essentially of α-Al₂O₃.

219. A process for treating alumina, the process comprising heating said alumina at a temperature of about 900° C. to about 1200° C. in the presence of steam and optionally at least one gas.

220. A process for converting AlCl₃.6H₂O into alumina, said process comprising heating AlCl₃.6H₂O at a temperature of about 900° C. to about 1200° C. in the presence of steam and optionally at least one gas, under conditions suitable to obtain the alumina.
